(19) United States
(12) Patent Application Publication
(10) Pub. No.: US 2003/0115114 A1
(43) Pub. Date: Jun. 19, 2003

(54) Method and system for transaction of goods

(75) Inventors: Jun Tateishi, Yokohama (JP); Masahiko Takano, Ushiku (JP)

Correspondence Address: Steve Y. Cho, Townsend and Townsend and Crew LLP, 8th Floor, Two Embarcadero Center, San Francisco, CA, 94111, US

(73) Assignee: Hitachi, Inc., Tokyo (JP)

(21) Appl. No.: 10/315,926

(22) Filed: Dec. 9, 2002

(30) Foreign Application Priority Data
Dec. 13, 2001 (JP) 2001-379390

(51) Int. Cl. G06F 17/60

(52) U.S. Cl. 705/26

(57) ABSTRACT

A method for performing a transaction amongst a plurality of participants including a first participant and a second participant includes receiving a first transaction information from the first participant wishing to perform a transaction in connection with one or more products of the given type with another participant, where the first and second participants purchase products of a given type from a product supplier at first and second purchase prices, respectively, and the first and second purchase prices are different from each other. The first transaction information includes at least price information on the one or more products without providing information on the first purchase price associated with the first participant. A second transaction information from the second participant agreeing to transact with the first participant based on the first transaction information is received. The second transaction information does not provide information on the second purchase price associated with the second participant.

### CROSS-REFERENCES TO RELATED APPLICATIONS

The present application is related to and claims priority from Japanese Patent Application No. 2001-379390, filed on Dec. 13, 2001.

### BACKGROUND OF THE INVENTION

The present invention relates to electronic commerce among a plurality of sales companies or parties.

Goods or products (hereinafter referred to simply as “goods”) generally move from a goods supplier (e.g., a manufacturer, etc.), a goods broker for a consumer (e.g., a sales company, etc.), and to a consumer in this order. The goods broker wishes to increase its sales, while reducing risks of having too much excess inventory to earn profits. On the other hand, a goods supplier, in order to make profits, wishes to limit the total volume of their goods to be distributed in a market.

In a case where a goods broker has a number of goods and has excessive inventory, or a case where it is expected the inventory will increase dramatically in the future, an opportunity for a transaction of goods will be arranged among goods brokers. Such arrangement will attain a good balance in respective volumes of goods owned by relevant goods brokers, thus contributing to reduce the volume of goods owned by such brokers.

Further, an appliance, a system and a medium which, for the purpose of providing an effective transaction of goods, compare information of a person who wishes to sell goods and that of another person who wishes to buy them, and sequentially achieves transactions one by one as the parties reach agreements, as disclosed in Japanese Patent Laid-open No. 11-232350.

### BRIEF SUMMARY OF THE INVENTION

The above-stated conventional method enables the transaction of goods among goods brokers by comparing conditions which includes a wish-to-sell price (or asking price) at the time of a sales with conditions which includes a wish-to-buy price (or offering price) at the time of a purchase, and then by sequentially completing transactions one by one as the conditions of both parties are satisfied, i.e., an agreement is reached.

However, with a transaction between a goods supplier (a manufacturer, etc.) and a goods broker (a sales company, etc.), sometimes the price for certain goods to be sold by the goods supplier to the goods broker may be different for different goods brokers, for example, such a case where discount rates become different as a result of business efforts rendered by goods brokers. Therefore, when an opportunity is arranged for a business transaction among goods brokers, a plurality of goods having different discount rates will become available even if the goods are the same. As a result, a goods broker who has been purchasing goods at a low discount rate from a goods supplier may sometimes be able to purchase and obtain goods cheaper from another goods broker who purchases goods from the goods supplier at a higher discount rates than that of the goods broker purchasing goods from the goods supplier. Consequently, the sales of goods which should originally have been sold to a goods broker who offers a lower discount rate and thus bringing large profits will be shifted to a sale to another goods broker who offers a larger discount rate and thus bringing small profits. When such situation occurs, profits of the goods supplier will be reduced, and the overall system may become unfit for the actual situation of the business transaction.

Due to above-described situation, in a case where a plurality of goods brokers exist and they purchase goods at different discount rates from a goods supplier, it has been conventionally difficult to arrange an opportunity for a business transaction among goods brokers.

The present embodiment solves such problems and provides a method and system for transaction of goods which enables to ensure profits of a goods supplier and perform transaction of goods among goods brokers even in a case where a plurality of goods brokers exist who purchase goods at different discount rates from the goods supplier.

In one embodiment, a method and a system for transaction of goods that use a wish (e.g., an initial asking price) of a seller to sell goods as a trigger, said method and system comprising: a goods broker's price storing unit which retains a price, for each goods, of relevant goods brokers to be purchased from a goods supplier; a sales information receiving unit which receives sales information, from a seller who wishes to sell goods, consisting of at least an identifier specifying a seller, a type of goods, date, quantity and a wish-to-sell price, calculates a wish-to-sell balance amount (the “wish-to-sell balance amount” shall be a value obtained by subtracting a “price of a seller to be purchased from a goods supplier” from a “wish-to-sell price of a seller”) by referring to a price, stored in a goods broker's price storing unit, for each goods, of relevant goods brokers to be purchased from a goods supplier, and adds the wish-to-sell balance amount to the sales information; a sales information storing unit which retains sales information that is received by a sales information receiving unit; a sales information referring unit which receives a sales information referring request from a goods broker and presents at least a type of goods, date, quantity, wish-to-sell balance amount and an identifier specifying sales information out of the sales information stored in the sales information storing unit; a purchase information receiving unit which receives purchase information that has been delivered from a sales broker (buyer) who wishes to buy goods, including at least an identifier specifying a buyer, an identifier specifying sales information, and quantity; and a transaction processing unit which achieves, for the case from a seller to a goods supplier, a buyer-seller contract (e.g., a transaction agreement) which includes “a price of a seller to be purchased from a goods supplier” that is retained in a goods broker's price storing unit, in addition to “an identifier specifying a seller” of sales information, “a type of goods” of sales information, “date” of sales information, “quantity” of purchase information, and “wish-to-sell balance amount” of sales information, and for the case from a goods supplier to a buyer, a buyer-seller contract which includes “a price of a buyer to be purchased from a goods supplier” that is retained in a goods broker's price storing unit, in addition to “an identifier specifying a buyer” of purchase information, “a type of goods” of sales information, “date” of sales information, “quantity” of purchase information, and “a wish-to-sell balance amount” of sales information, and deletes sales information from a sales information storing unit.

Further, a method and a system for transaction of goods which use a wish (e.g., an initial offering price) of a buyer to purchase goods as a trigger, said method and system comprising: a goods broker's price storing unit which retains a price, for each goods, of relevant goods brokers to be purchased from a goods supplier; a purchase information receiving unit which receives purchase information, from a buyer who wishes to buy goods, including at least an identifier specifying a buyer, a type of goods, date, quantity and a wish-to-buy price, calculates a wish-to-buy balance amount (the “wish-to-buy balance amount” shall be a value obtained by subtracting a “price of a buyer to be purchased from a goods supplier” from a “wish-to-sell price of a buyer”) by referring to a price, for each goods, of relevant goods brokers to be purchased from a goods supplier, and adds the wish-to-buy balance amount to the purchase information; a purchase information storing unit which retains purchase information that is received by a purchase information receiving unit; a purchase information referring unit which receives a purchase information referring request from a goods broker and presents at least a type of goods, date, quantity, a wish-to-buy balance amount and an identifier specifying purchase information out of the purchase information stored in a purchase information storing unit; a sales information receiving unit which receives sales information, from a goods broker (seller) who wishes to sell goods, including at least an identifier specifying a seller, an identifier specifying purchase information, and quantity; and a transaction processing unit which achieves, for the case from a seller to a goods supplier, a buyer-seller contract which includes “a price of a seller to be purchased from a goods supplier” that is retained in a goods broker's price storing unit, in addition to “an identifier specifying a seller” of sales information, “a type of goods” of purchase information, “date” of purchase information, “quantity” of sales information, and “a wish-to-sell balance amount” of purchase information, and for the case from a goods supplier to a buyer, a buyer-seller contract which includes “a price of a buyer to be purchased from a goods supplier” that is retained in the goods broker's price storing unit, in addition to “an identifier specifying a buyer” of purchase information, “a type of goods” of purchase information, “date” of purchase information, “quantity” of sales information, and “a wish-to-buy balance amount” of purchase information, and deletes sales information from a sales information storing unit.

In one embodiment, a method for performing a transaction amongst a plurality of participants including a first participant and a second participant is disclosed. The first and second participants purchase products of a given type from a product supplier at first and second purchase prices, respectively. The first and second purchase prices are different from each other. The method includes receiving a first transaction information from the first participant wishing to perform a transaction in connection with one or more products of the given type with another participant. The first transaction information includes at least price information on the one or more products without providing information on the first purchase price associated with the first participant. A second transaction information from the second participant agreeing to transact with the first participant based on the first transaction information is received. The second transaction information does not provide information on the second purchase price associated with the second participant. The first transaction information is stored in an information receiving unit that is accessible to the plurality of participants. A first information request from the second participant is received, the first request providing one or more search criteria. Upon determining that the first transaction information satisfies the search criteria, at least a portion of the first transaction information is provided to the second participant, wherein the information provided to the second participant is sufficient for the second participant to determine a transaction price of the one or more products as realized by the second participant but insufficient for the second participant to determine the first purchase price associated with the first participant.

In another embodiment, a method for trading a transactional right for a product in a network environment having a plurality of participants and a product supplier is disclosed. The method includes receiving sales information from a first participant for a purchase right to a product of a given type being supplied by the supplier, the first participant having agreed to pay a first purchase price to the supplier for the one or more products in connection with the purchase right. Information on the sales information is provided to a second participant, the information on the sales information being insufficient for the second participant to determine the first purchase price but sufficient to enable the second participant to determine a total purchase price for the product. An acceptance of the purchase right is accepted from the second participant based on the information provided on the sales information to the second participant.

In another embodiment, a system for trading a purchase right to a product of a given type includes a network and a server system coupled to a plurality of clients via the network, the server system being associated with the product supplier and the clients being associated with product brokers. The server system includes an information storage area including: code for receiving sales information from a first client for a purchase right to a product of a given type being supplied by the supplier, wherein a first product broker associated with the first client has agreed to pay a first purchase price to the supplier for the one or more products in connection with the purchase right; code for providing information on the sales information to a second client, the information on the sales information being insufficient for a second product broker of the second client to determine the first purchase price but sufficient to enable the second user to determine a total purchase price for the product; and code for receiving an acceptance of the purchase right from the second product broker based on the information provided on the sales information.

In yet another embodiment, a computer readable medium storing information relating to a method for performing a transaction amongst a plurality of participants including a first participant and a second participant is disclosed. The first and second participants purchase products of a given type from a product supplier at first and second purchase prices, respectively. The first and second prices are different from each other. The medium includes code for receiving a first transaction information from the first participant wishing to perform a transaction in connection with one or more products of the given type with another participant, the first transaction information including at least price information on the one or more products without providing information on the first purchase price associated with the first participant; and code for receiving a second transaction information from the second participant agreeing to transact with the first participant based on the first transaction information, the second transaction information not providing information on the second purchase price associated with the second participant.

### BRIEF DESCRIPTION OF THE DRAWINGS

FIG. 1 is a configuration diagram showing a method and a system for goods transaction according to one embodiment of the present invention.

FIG. 2 is a flow chart showing a method for goods transaction and operations of a system according to one embodiment of the present invention.

FIG. 3 is a flow chart showing a method for goods transaction and operations of a system according to one embodiment of the present invention.

FIG. 4 is flow chart showing a method for goods transaction and operations of a system according to one embodiment of the present invention.

FIG. 5 is flow chart showing a method for goods transaction and operations of a system according to one embodiment of the present invention.

FIG. 6 is a diagram showing the overall image of the present invention.

FIG. 7 is a diagram showing the flow of information in a method and a system for goods transaction according to one embodiment of the present invention.

FIG. 8 is a diagram showing the flow of information in a method and a system for goods transaction according to one embodiment of the present invention.

FIG. 9 is a diagram showing a sales information entering screen in a method and a system for goods transaction according to one embodiment of the present invention.

FIG. 10 is a diagram showing a data table of information which is stored in a goods broker's price storing unit in a method and a system for goods transaction according to the preferred embodiment of one invention.

FIG. 11 is a diagram showing a data table of information which is stored in a sales information storing unit in a method and a system for goods transaction according to one embodiment of the present invention.

FIG. 12 is a diagram showing a sales information referring and purchase information entering screen in a method and a system for goods transaction according to one embodiment of the present invention.

FIG. 13 is a diagram showing a purchase information entering screen in a method and a system for goods transaction according to one embodiment of the present invention.

FIG. 14 is a diagram showing a data table of information which is stored in a purchase information storing unit in a method and a system for goods transaction according to one embodiment of the present invention.

FIG. 15 is a diagram showing a purchase information referring and sales information entering screen in a method and a system for goods transaction according to one embodiment of the present invention.

### DETAILED DESCRIPTION OF THE INVENTION

Hereinafter, preferred embodiments of the present invention will be concretely described with reference to the drawings.

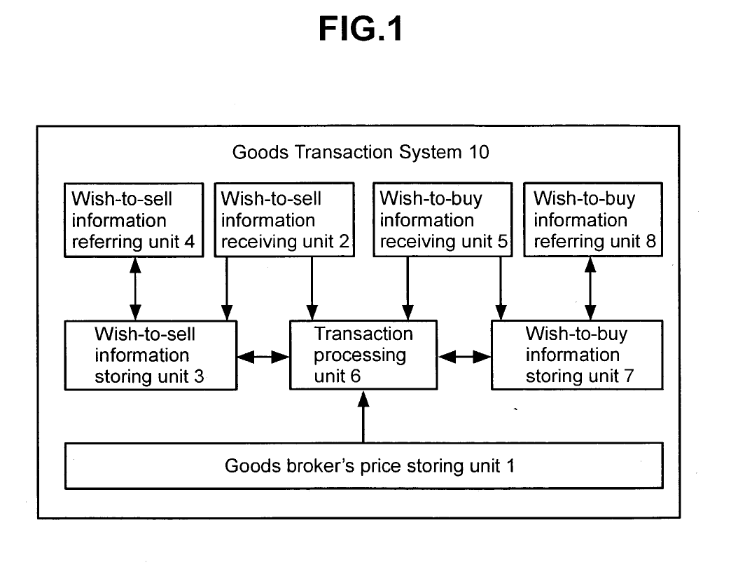

A goods transaction system 10 according to a preferred embodiment has a configuration shown in FIG. 1. A goods broker's price storing unit 1 (“price storing unit”) of the goods transaction system 10 keeps a goods price of relevant goods broker to be purchased from a goods supplier according to goods. Further, the transaction system 10 comprises a sales information receiving unit 2, a sales information storing unit 3, a sales information referring unit 4, a purchase information receiving unit 5, a transaction processing unit 6, a purchase information storing unit 7, and a purchase information referring unit 8. The sales information receiving unit 2 (also referred to as “wish-to-sell information receiving unit”) receives sales information delivered from a goods broker who wishes to sale goods for a seller and calculates a wish-to-sell balance amount. The sales information storing unit 3 (also referred to as “wish-to-sell information storing unit”) keeps sales information. The sales information referring unit 4 (also referred to as “wish-to-sell information referring unit”) receives a sales information referring request delivered from a goods broker for a buyer of goods and presents sales information retrieved and extracted from the sales information storing unit 3 to a goods broker for a buyer. The purchase information receiving unit 5 (also referred to as “wish-to-buy information receiving unit”) which receives purchase information from a goods broker for a buyer who wished to buy goods and calculates a wish-to-buy balance amount. The purchase information storing unit 7 (also referred to as “wish-to-buy information storing unit”) keeps purchase information. The purchase information referring unit 8 (also referred to as “wish-to-buy information referring unit”) receives a purchase information referring request from a goods broker for a buyer and presents purchase information retrieved and extracted from the purchase information storing unit 7 to a goods broker for the buyer.

A sales contract or agreement is made between a first goods broker (“buyer”) who wishes to purchase goods from a second goods broker (“seller”) according to the contents of “sales information” if the sales information is acceptable to the buyer. In one embodiment, this involves making two contracts: (1) between the buyer and the goods supplier and (2) between the seller and the goods supplier. Accordingly, the supplier directly ships the goods that have been intended for the second broker (seller) to the first broker (buyer) since the seller had sold his purchase rights to the buyer. Thereafter, the sales information is deleted from the sales information storing unit 3.

As used herein, the term “sales information” refers to information provided by a seller that is sufficient to initiate or enter into a sales agreement with a buyer. In one embodiment, the sales information includes one or more of the following: pricing information including a wish-to-sell price and wish-to-sell balance amount, identification information of goods, quantity of goods, delivery date of goods, purchase information identifier, and the like.

Similarly, in a case where a seller decides to perform a transaction with a buyer subject to the extracted “wish-to-buy price”, both buyer-seller contract made “between a seller and a goods supplier” and “between a buyer and a goods supplier” shall be achieved, and further purchase information shall be deleted from the purchase information storing unit 7. It should be noted that the calculation processing to be executed by the goods transaction system 10 shown in FIG. 1 is executed by a calculation processor (not shown).

Here, information stored in the price storing unit 1 is price information used when a goods supplier is going to sell goods to a goods broker who is a customer of the goods supplier. Different prices are arranged according to relevant goods brokers in the price storing unit 1 (there may be a case where prices are all the same).

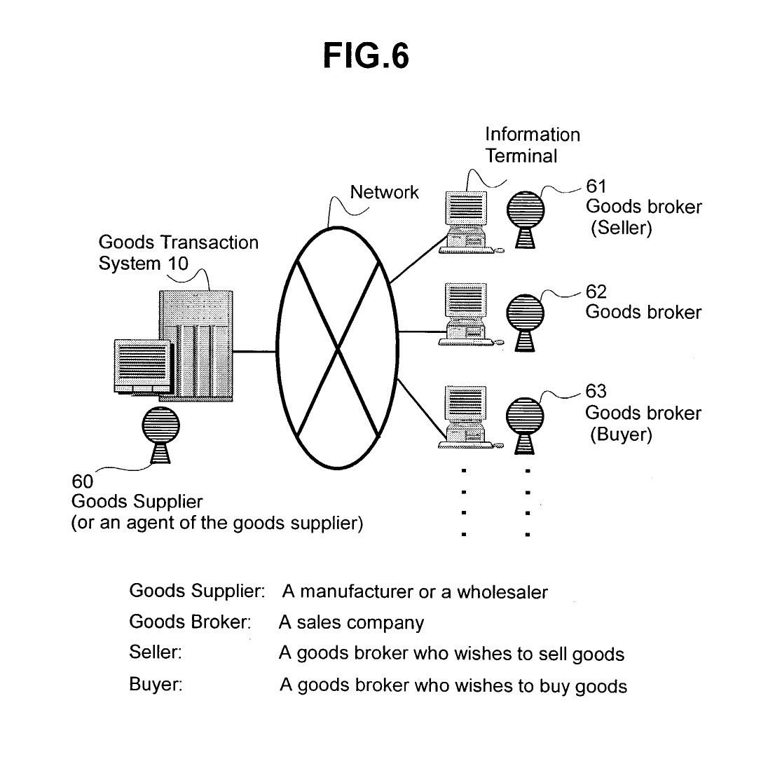

FIG. 6 shows a preferred embodiment for a method for goods transaction wherein the goods transaction system 10 is used through a network, such as the Internet.

In FIG. 6, the goods transaction system 10 is controlled by a goods supplier 60 or by a business agent for the goods supplier 60. In addition, an information terminal (unit) owned and operated by goods brokers 61, 62 and 63 is connected to a goods transaction system that is managed by a goods broker or a representative for the goods broker. Here, among goods brokers 61, 62 and 63, the goods broker 61 wishes to sell goods, and the goods broker 63 wishes to purchase goods.

In the present embodiment, a description shall be made by assuming that goods to be transacted from a seller to a buyer via a goods supplier imply such goods that are ordered by the seller from a goods supplier, those that have not been produced, or those that have been produced but have not been delivered. More specifically, the explanation is made not in the form of a transaction of goods themselves, but in the form of a transaction of “a purchasing right of goods (a right to purchase goods from a certain goods supplier)” owned by a seller. Alternatively, the seller 61 may attempt to sale goods that have already been delivered by the goods supplier.

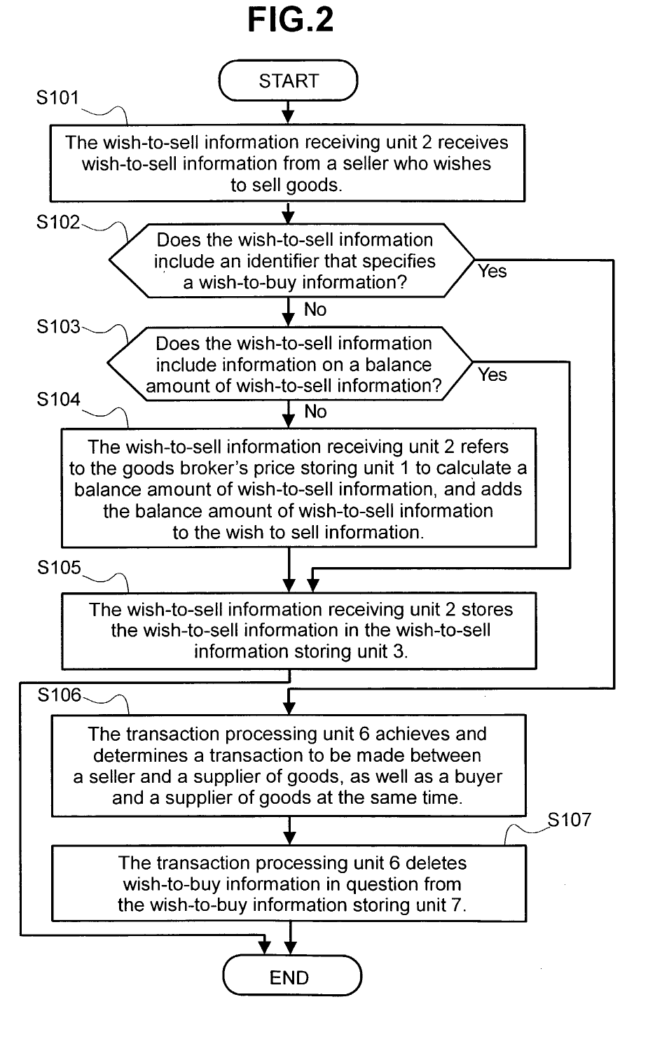

Next, a method for goods transaction and operations of a system 10 of the preferred embodiment will be described by referring to flow charts shown in FIGS. 2, 3, 4 and 5. FIG. 2 is a chart describing a flow of inputting sales information by a seller who wishes to sell goods. First, a sales information receiving unit 2 receives sales information delivered by a seller who wishes to sell goods (S101). Next, the sales information receiving unit 2 judges whether the sales information contains an identifier specifying purchase information (S102).

As used herein, the term “purchase information” refers to information provided by a buyer that is sufficient to initiate or enter into a sales agreement with a seller. In one embodiment, the purchase information includes one or more of the following: price information including a wish-to-buy price and a wish-to-buy balance amount, identification information of goods, quantity of goods, delivery date of goods, sales information identifier, and the like.

As used herein, the term “transaction information” refers to information provided by a seller or buyer that is sufficient to initiate or enter into a sales agreement between parties, e.g., the sales information or purchase information.

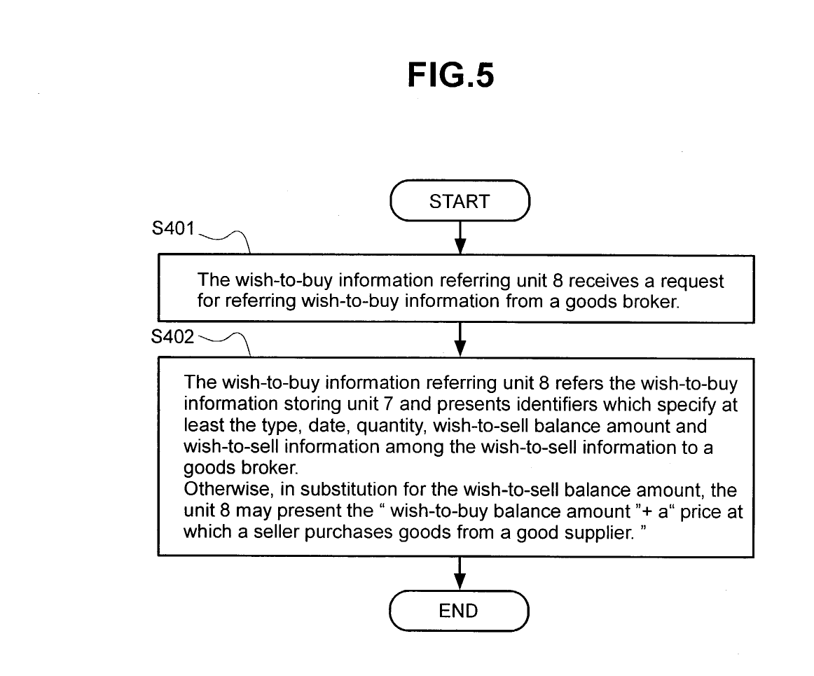

Here, although not shown in FIG. 2, if a seller has accessed a purchase information storing unit 7 before proceeding to step S101 and retrieved purchase information which matches the sales information of the seller, the seller has already obtained an identifier specifying the purchase information (to be described later in connection with FIG. 5). If the sales information does not contain an identifier specifying the purchase information (i.e., the judgment of step S102 is “No”), the sales information receiving unit 2 judges whether the sales information contains information of wish-to-sell balance amount or not (S103). If the sales information does not contain information of wish-to-sell balance amount (i.e., the judgment of step S103 is “No”), the sales information receiving unit 2 will refer the goods broker's price storing unit 1 and add wish-to-sell balance amount to the sales information (S104). The sales information receiving unit 2 keeps the sales information to which a wish-to-sell balance amount has been registered in the sales information storing unit 3 (S105).

Here, if the sales information contains an identifier specifying purchase information (i.e., the judgment of step S102 is “Yes”), a transaction processing unit 6 will achieve both buyer-seller contracts “between a seller and a goods supplier” and “between a buyer and a goods supplier” (S106), and delete corresponding purchase information from the purchase information storing unit 7 (S107).

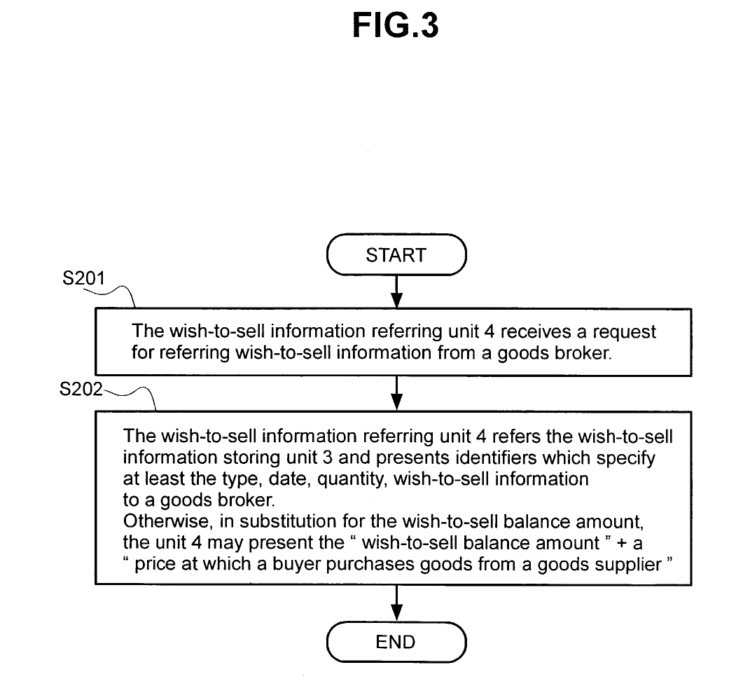

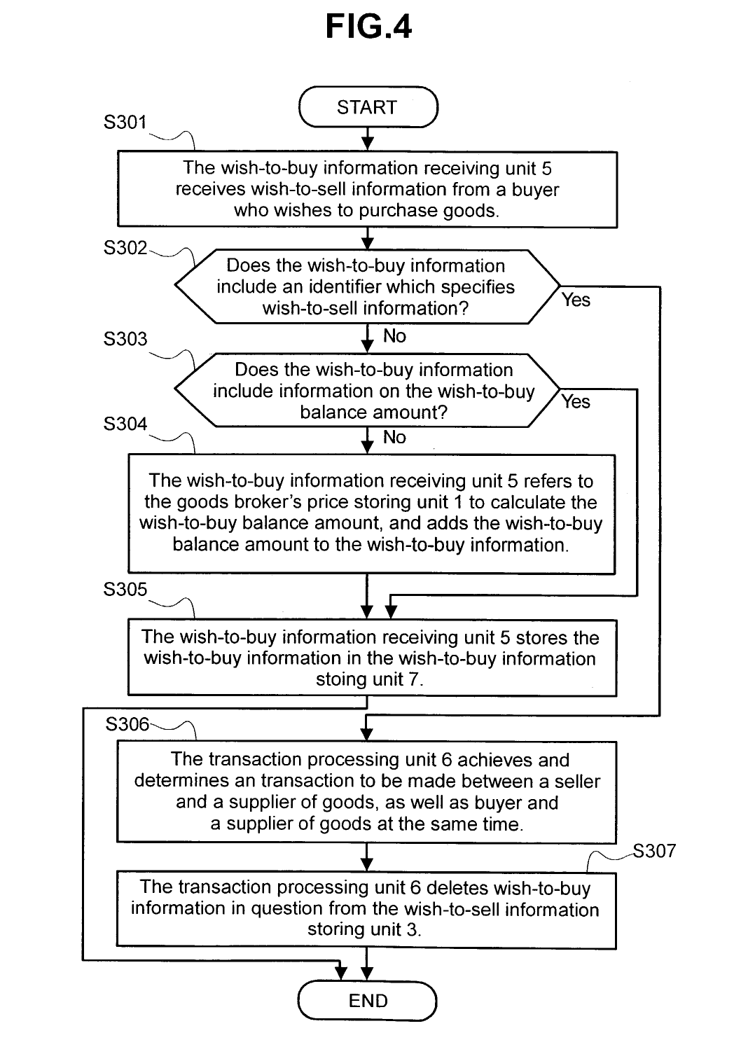

FIG. 3 describes a goods transaction method and operations of the system 10 for a case where a buyer inputs a request for sales information. First, the sales information referring unit 4 receives a request for sales information from a buyer (S201). The sales information referring unit 4 refers to the sales information storing unit 3 and transmits the appropriate sales information to a terminal unit of the buyer via a network (S202). Here, in the preferred embodiment, the sales information includes at least one or more of the following: a type (or a name) of goods, date (time of delivery), quantity, a wish-to-sell balance amount, and an identifier that uniquely identify a given sales information from other sales information. The request for sales information may include information about one or more of the following keys: a type of goods, delivery date, quantity of goods, a wish-to-sell balance amount, or the like. In addition, in step S202, instead of the information of wish-to-sell balance amount, “an wish-to-sell balance amount”+“a price of the goods for the buyer when purchased from a goods supplier” may be presented by referring to the price storing unit 1. It should be noted that, in the subsequent process after the flow shown in FIG. 3, a buyer may obtain an identifier specifying the sales information. Consequently, in the subsequent processes after the flow shown in FIG. 4 to be described later, “purchase information containing an identifier specifying sales information” may be transmitted via a network.

FIG. 4 is a diagram describing a goods transaction method and operations of the system 10 in a case where a buyer who wishes to purchase goods is going to input purchase information. First, the purchase information receiving unit 5 receives purchase information from a buyer who wishes to purchase goods (S301). Then, the purchase information receiving unit 5 judges whether or not the purchase information contains an identifier specifying sales information (S302). Here, although not shown in FIG. 4, if a buyer has accessed the sales information storing unit 3 before proceeding to step S301 and has identified a given sales information that matches the requirements of the buyer, the buyer, i.e., the purchase information, has an identifier specifying the sales information in question. If the purchase information does not include an identifier specifying the sales information (i.e., the judgment of step S302 is “No”), the purchase information receiving unit 5 judges whether or not the purchase information contains information of wish-to-buy balance amount (S303). If the purchase information does not contain information of wish-to-buy balance amount (i.e., the judgment of step S303 is “No”), then the purchase information receiving unit 5 accesses the goods broker's price storing unit 1, calculate an wish-to-buy balance amount, and add the wish-to-buy balance amount to the purchase information (S304).

The purchase information receiving unit 5 keeps the purchase information to which a wish-to-buy balance amount has been registered in the purchase information storing unit 3 (S305). Here, if the purchase information contains an identifier specifying sales information (i.e., the judgment of step S302 is “Yes”), the transaction processing unit 6 will achieve both buyer-seller contracts “between a seller and a goods supplier” and “between a buyer and a goods supplier” (S306), and delete corresponding sales information from the sales information storing unit 3 (S307).

FIG. 5 describes a goods transaction method and operations of the system 10 for a case where a goods broker for a seller inputs a request for purchase information. First, the purchase information referring unit 8 receives a request for purchase information from a seller (S401). The purchase information referring unit 8 accesses the purchase information storing unit 7 and transmits purchase information to a terminal unit of the seller via a network (S402). Here, in the present embodiment, the purchase information includes at least one or more of the following: a type (or a name) of goods, date (time of delivery), quantity, a wish-to-buy balance amount and an identifier that identify purchase information, and the like. In addition, for the request for purchase information includes one or more of the following information to search for relevant purchase information: a type of goods, delivery date, quantity, a wish-to-buy balance amount, and the like. In addition, in step S402, instead of the information of wish-to-buy balance amount, “an wish-to-buy balance amount”+“a price for a seller” may be presented by referring to the goods broker's price storing unit 1, so that the seller may review the actual purchase price for the goods. It should be noted that, in the subsequent process after the flow shown in FIG. 5, a goods broker for a seller may obtain an identifier specifying the purchase information. Consequently, in the subsequent processes after the flow shown in FIG. 2 described earlier, “sales information containing an identifier specifying purchase information” may be transmitted via a network.

In the embodiment of FIGS. 3 and 5 above describes a case where a desired matter is extracted when the “wish-to-sell balance amount” presented by a seller and the “wish-to-buy balance amount” presented by a buyer coincide. However, the case is not limited thereto, and in addition to the case shown here, for example, there may be a case where a “range of wish-to-sell balance amount” is presented, while the seller provides the wish-to-sell price with a certain range and the buyer provides the wish-to-buy price with a certain range. In this case, the extraction processing of a desired matter is executed when the ranges provided by the seller and the buyer overlap. Furthermore, it may be possible that the extraction processing is executed when either of the seller or the buyer presents a desired balance amount, the other presents a desired balance amount with a certain range, and the value of such desired balance amount is within the range of desired balance amount.

In addition, regarding the quantity of goods, date of delivery, etc., it may be arranged so that they may be retrieved under various conditions as is the above-stated case where the desired balance amount is provided with a certain range, without limiting the conditions to the case of a perfect match.

Next, a goods transaction method and operations of the system 10 will be described in details by referring to FIG. 10. In an example shown in FIG. 10, a manufacturer (goods supplier) supplies a product A to two sales companies (goods brokers; a sales company 1 and a sales company 2). The sales company 1 purchases the product A at 100 yen from the manufacturer, and the sales company 2 purchases the product at 80 yen from the manufacturer. In the goods broker's price storing unit 1, information of “Product A, Sales Company 1, 100 yen” and “Product A, Sales Company 2, 80 yen” are registered. Information stored in the goods broker's price storing unit 1 is registered, for example, in a table configuration as shown in FIG. 10.

Assuming the current time is July 1st, the sales company 2 issued orders of “10 units of product A to be delivered on August 1st (Order 1)” and “10 units of product A to be delivered on September 1st (Order 2)”, and the sales company 1 issued an order of “5 units of product A to be delivered on August 1 st (Order 3).” The manufacturer has no production schedules for the product A other than these three orders.

At present, the sales company 1 has inquiries from consumers, and they are in a state that they will be able to secure much more orders if they can make a further discount of 10 yen. The sales company 2 has no specific inquiries from consumers. Under such circumstances, the sales company 2 wishes to cancel the orders for the product A even if they have to pay a penalty fee of 10 yen since they do not want to have excess inventories. It is assumed that no information is registered with the sales information storing unit 3 and the purchase information storing unit 7 at this instance.

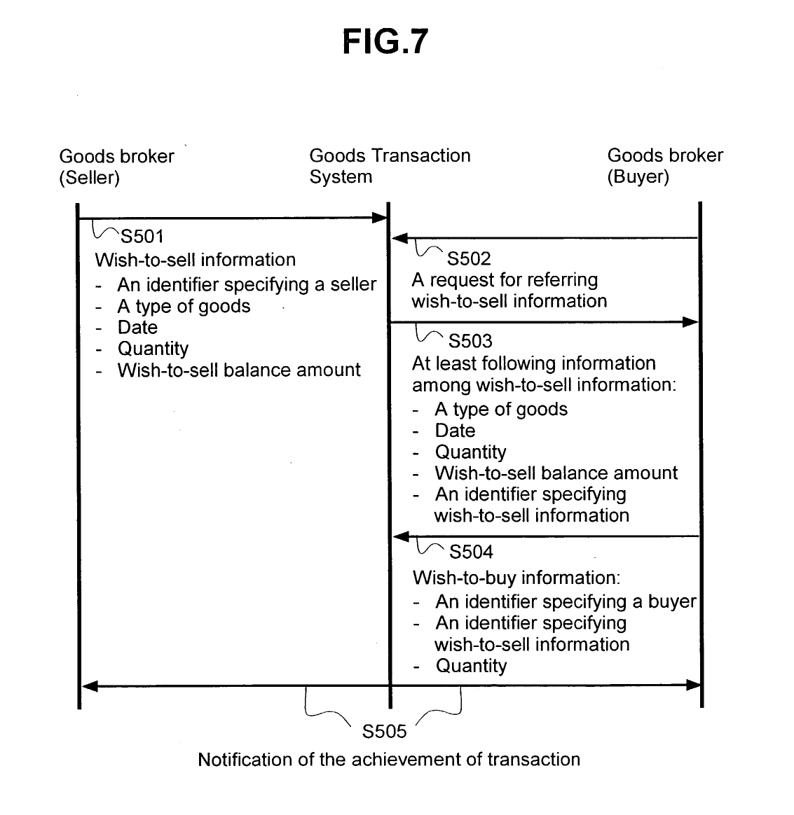

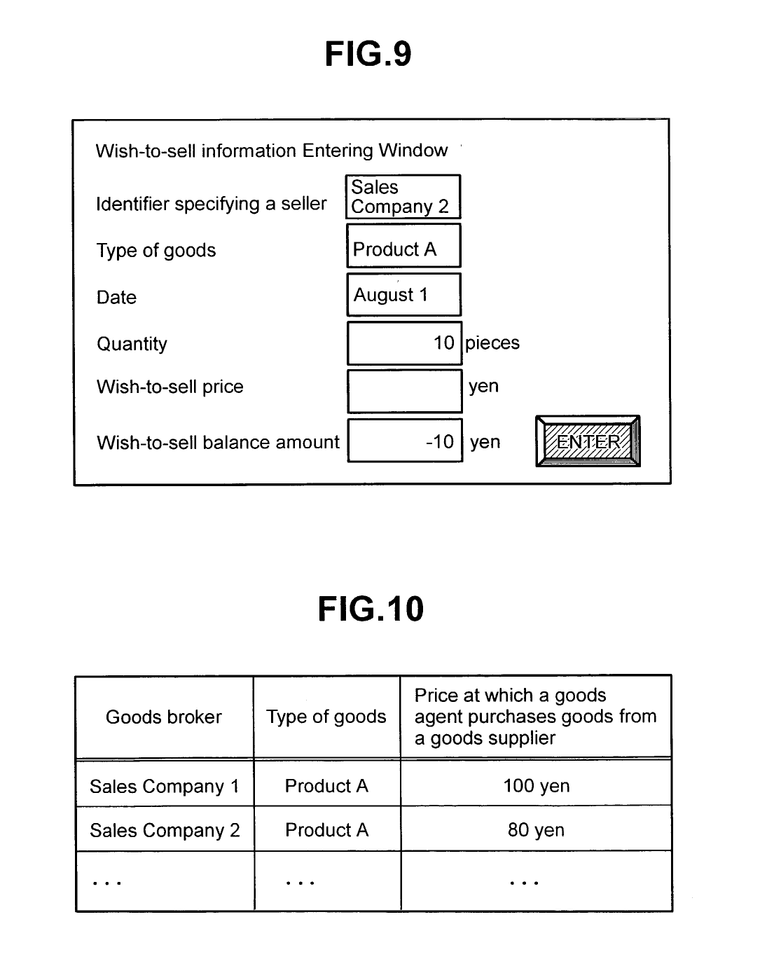

First, an explanation will be made specifically for the flow of information where sales information from a seller is used as a trigger, by referring to FIG. 7 at the same time. The sales company 2 or seller will make a following registration to the goods transaction system 10 so as not to have excess inventories. The sales company 2 registers sales information of “10 units of product A to be delivered on August 1st” (above-stated Order 1) to the goods transaction system 10 (S501). The sales company 2 executes a registration procedure through a screen shown in FIG. 9. The sales company 2 enters a seller identifier (e.g., an account number, pseudonym, or the like), a type of goods, delivery date, quantity, and a wish-to-sell balance amount according to instructions displayed on the screen. In FIG. 9, the wish-to-sell balance amount is entered as “−10” (equivalent to a penalty fee of 10 yen). For a wish-to-sell price, it is not necessary to enter a wish-to-sell balance amount according to one embodiment of the present invention. Thereafter, executing the “enter” button registers the sales information to the sales information storing unit 3.

First, the sales information receiving unit 2 receives sales information from the sales company 2 which is a seller (S101). The sales information include a seller identification or identifier “sales company 2”, a type of goods “product A”, date “August 1”, quantity “10 units”, and an wish-to-sell balance amount “−10 yen” (or an wish-to-sell price “70 yen”). The sales information receiving unit 2 determines whether or not the sales information contains an identifier specifying purchase information (S102). In this example, since it does not contain an identifier specifying purchase information, the sales information receiving unit 2 determines whether or not the sales information contains information of a wish-to-sell balance amount (S103). In this example, it contains information of a wish-to-sell balance amount. If the information of a wish-to-sell balance amount is not contained and the wish-to-sell price is listed as 70 yen, the sales information receiving unit 2 refers to the “Product A, Sales Company 2, 80 yen” in the price storing unit 1 to calculate the wish-to-sell balance amount of “−10 yen” since “70 yen −80 yen=−10 yen” (S104). Due to such processing, the sales information will be an identifier “sales company 2” identifying a seller, a type of goods “product A”, date “August 1”, quantity “10 units”, a wish-to-sell price “70 yen”, and an wish-to-sell balance amount “−10 yen”. For the sales information, there may be a case where the an wish-to-sell balance amount “−10 yen” will be registered initially instead of then wish-to-sell price “70 yen.” In this case, it is not necessary to calculate the wish-to-sell balance amount. Thereafter, the sales information receiving unit 2 stores the sales information in which the wish-to-sell balance amount is registered to the sales information storing unit 3 (S105).

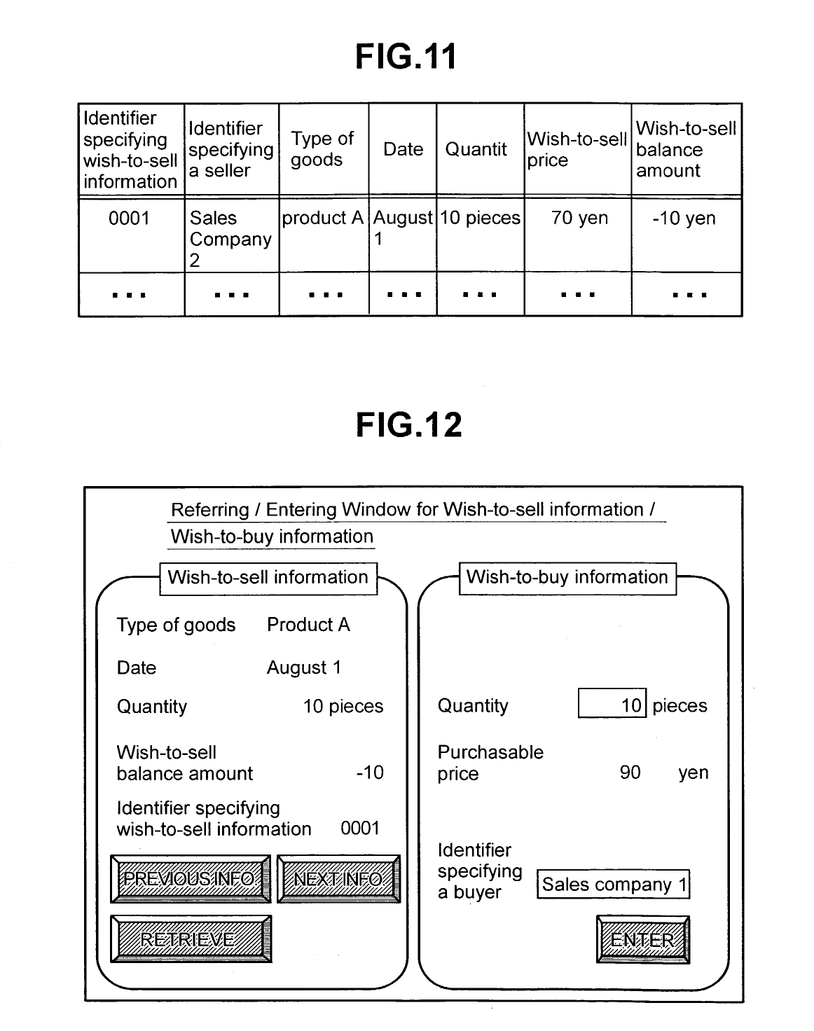

As a result of the above processing, the sales information (containing an identifier “sales company 2” specifying a seller, a type of goods “product A”, date “August 1”, quantity “10 units”, an wish-to-sell price “70 yen”, and an wish-to-sell balance amount “−10 yen”) is registered in the sales information storing unit 3. FIG. 11 shows an exemplary data format used to register the sales information.

On the other hand, since the sales company 1 has a number of inquiries for the product A from consumers, it uses the goods transaction system 10 to check sales information whether any transaction information regarding the product A is available or not. FIG. 7 shows the procedures.

The sales company 1 that wishes to purchase goods requests the goods transaction system 10 to search for relevant sales information (S502), and the goods transaction system 10 displays selected sales information that satisfy the conditions of the request on a screen as shown in FIG. 12 (S503). The sales company 1 enters purchase information through the screen as shown in FIG. 12 (S504).

More specifically, first, the sales information referring unit 4 receives a request for sales information from the sales company 1 or buyer (S201). The sales information referring unit 4 refers to the sales information storing unit 3, and provides sales information that satisfies the conditions of the buyer's request from the sales information that is registered in the sales information storing unit 3 (S202), as illustrated in FIG. 12. The information provided are: a type of goods “product A”, date “August 1”, quantity “10 units”, an wish-to-sell balance amount “−10 yen”, and an identifier “No. 0001 sales information” which identifies the sales information to the sales company 1. At this time, a purchasable price “90 yen” may be presented instead of the wish-to-sell balance amount “−10 yen” by referring to the “product A, sales company 1, 100 yen” in the price storing unit 1.

The sales company 1, upon seeing the contents of sales information presented by the system, registers a transaction to the goods transaction system 10 if the transaction is desired. In this case, first, a purchase information receiving unit 5 receives purchase information from a buyer “sales company 1” who wishes to purchase goods (S301). The purchase information contains an identifier “sales company 1” specifying the buyer, an identifier “No. 0001 sales information” specifying sales information, and quantity “10 units.” Next, the purchase information receiving unit 5 determines whether the purchase information contains an identifier specifying sales information or not (S302). Here, since the purchase information contains the identifier which specifies sales information, the transaction processing unit 6 achieves both buyer-seller contracts made “between a seller and a goods supplier” and “between a buyer and a goods supplier” (S306), and then, it deletes the corresponding sales information from the sales information storing unit 3 (S307). Between a seller and a goods supplier, the cancellation of an order for a type of goods “product A”, date “August 1”, quantity “10 units” and a penalty “−10 yen” (−1×−10 yen) will be achieved, and between a buyer and a goods supplier, the buyer-seller contract of a new order for a type of goods “product A”, date “August 1”, quantity “10 units”, and a price “90 yen” will be achieved. The decision of such cancellation and the achievement of such contract are notified to terminal units of the sales company 1 and the sales company 2 via a network. As a result, sales information containing a type of goods “product A”, date “August 1”, quantity “10 units”, an wish-to-sell balance amount “−10 yen” and an identifier “No. 1 sales information” specifying sales information is deleted from the sales information storing unit 3.

With the above-stated embodiment, the transaction to sell the purchasing right of goods under the “Order 1” from the sales company 2 to the sales company 1 is realized. However, for the manufacturer which mediates the transaction of the purchasing right of goods, the direct profit arising out of the transaction is break-even (±0). This happens because the “Order 1” (unit price: 80 yen) originally placed by the sales company 2 is handled as if it were the “Order 1” (unit price: 100 yen) placed by the sales company 1, and thus enabling the mechanism where no margins, etc. will be generated through the mediation work. Provided that, however, in this case, the total sales of a manufacturer will be increased since the purchasing right of goods is sold to a company which has a higher unit price of sales. Further, in a transaction using the goods transaction system 10, a manufacturer can deliver an adequate volume of goods to a market while maintaining the respective competitive power of marketing of the sales companies, since the manufacturer will achieve a transaction without publicly announcing a unit price of sales that are arranged for each sales company.

Further, the sales company 1 which purchases goods can increase necessary volume of inventories through the transaction in time with desired delivery time. In addition, the sales company 1 can purchase goods from the manufacturer at a cheaper price (90 yen in this case) than the price (100 yen in this case) at which the sales company usually purchases goods from the manufacturer. Due to such arrangement, the registration process of purchase information to the goods transaction system 10 can be promoted. Further, a transaction of purchasing right of goods that is executed via the goods transaction system 10 can also be promoted.

On the other hand, the sales company 2 which sells the purchasing right of goods can lower an undesirable increase in inventories since a buyer (sales company 1) is secured through a transaction before the delivery of the goods. In addition, the sales company 2 may have to pay a penalty fee in regard to the cancellation of order to the manufacturer, but if the usual penalty fee set by the manufacturer is 20 yen, the penalty fee resulting from this transaction is only a half of the usual penalty fee in this case. By enabling such mechanism of the goods transaction system 10, the registration of sales information to the goods transaction system 10 can be promoted, and also the transaction via the system 10 can be promoted. It should be noted that the penalty fee may be individually set as sales information by a sales company which play the part of a seller within the range of fees set by the manufacturer.

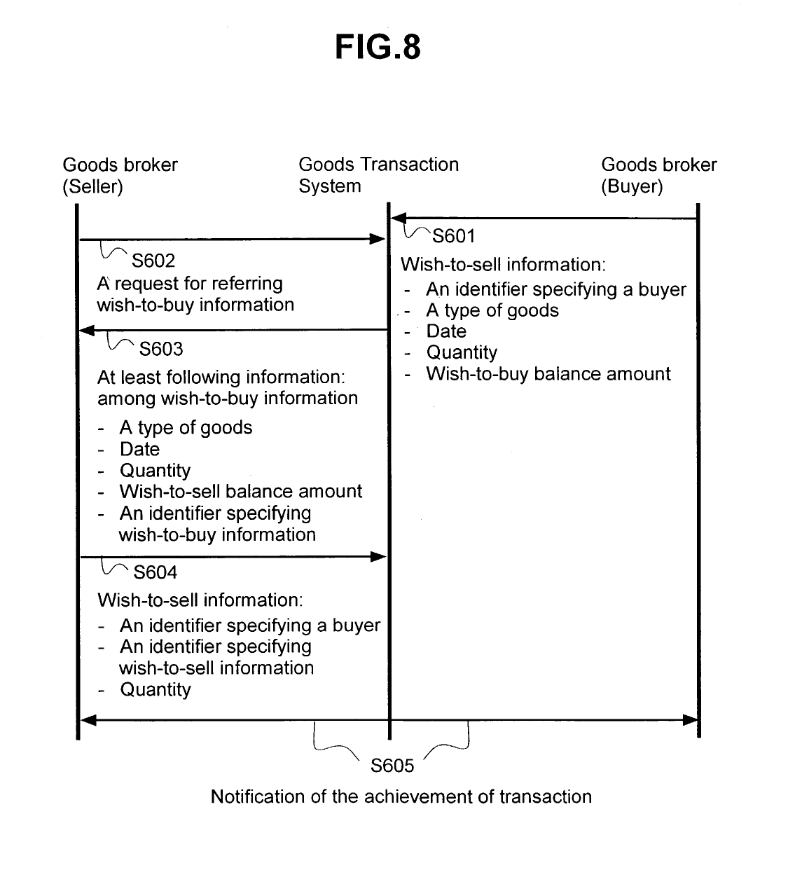

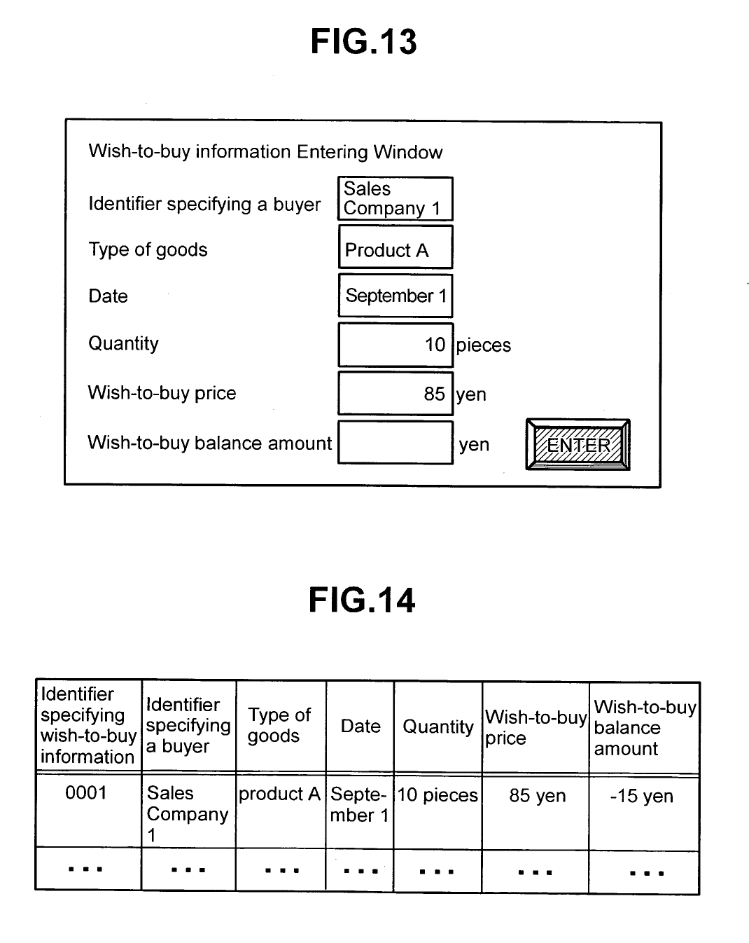

Next, a case where the sales company 1 additionally requires the “product A” will be described. The sales company 1 which additionally requires the “product A” first makes a registration with the goods transaction system. This implies a flow of information in a case where purchase information from a buyer is used as a trigger, and the specific description will be made by referring also to FIG. 8. The sales company 1 or buyer registers purchase information with the goods transaction system (S601). The registration is executed through a screen as shown in FIG. 13. In FIG. 13, an example of entering a wish-to-buy price, instead of entering a wish-to-buy balance amount, is shown.

More specifically, first, the purchase information receiving unit 5 receives purchase information delivered from the sales company 1 or buyer who wishes to purchase goods (S301). The purchase information contains an identifier “sales company 1” specifying a buyer, a type of goods “product A”, date “September 1”, quantity “10 units”, and an wish-to-purchase price “85 yen” (as illustrated in FIG. 13). The purchase information receiving unit 5 judges whether the purchase information contains an identifier specifying sales information or not (S302). In this example, since an identifier specifying sales information is not contained, the purchase information receiving unit 5 determines whether the purchase information contains information of an wish-to-purchase balance amount or not (S303). In this example, since the information of a wish-to-purchase balance amount is not contained, the purchase information receiving unit 5 refers to “product A, sales company 1, 100 yen” in the goods broker's price storing unit 1, calculates a wish-to-buy balance amount “—15 yen” in the manner like “85 yen −100 yen=−15 yen”, and adds the wish-to-buy balance amount to the purchase information (S304). Due to such processing, the purchase information will be an identifier “sales company 1” specifying a seller, a type of goods “product A”, date “September 1”, quantity “10 units”, an wish-to-buy price “85 yen”, and an wish-to-buy balance amount “−15 yen”. For the purchase information, there may be a case where the a wish-to-buy balance amount “−15 yen” will be registered initially instead of an wish-to-buy price “85 yen.” In this case, it is not necessary to calculate the wish-to-buy balance amount.

Next, the purchase information receiving unit 2 stores the purchase information to which a wish-to-buy balance amount is registered to the purchase information storing unit 7 (S305). In the purchase information storing unit 7, a certain piece of purchase information (containing an identifier “sales company 1” specifying a buyer, a type of goods “product A”, date “September 1”, quantity “10 units”, an wish-to-sell price “85 yen”, and an wish-to-buy balance amount “−15 yen”) is registered in the purchase information storing unit. The purchase information is registered, for example, in a table shown in FIG. 14.

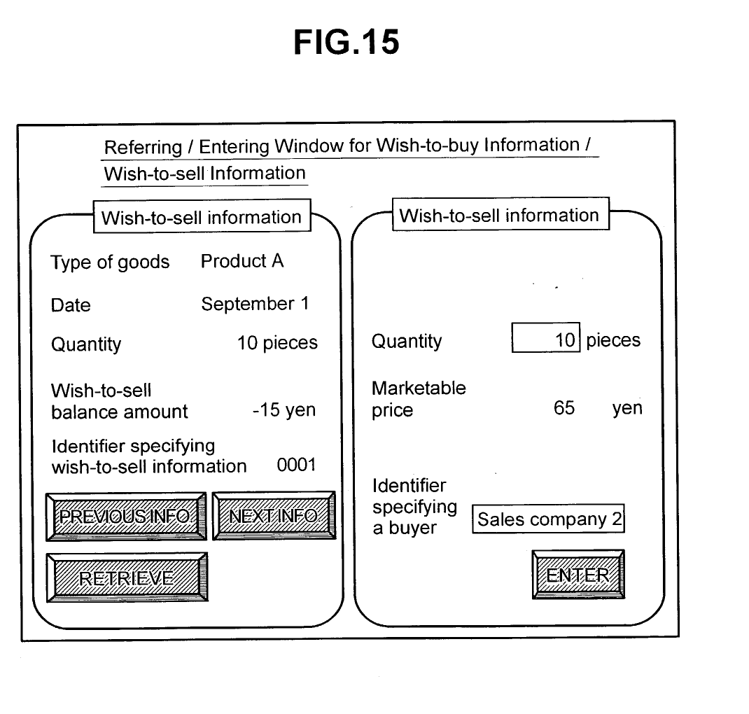

The sales company 2 checks purchase information with the goods transaction system to further reduce its inventories. The sales company 2 or seller requests the goods transaction system 10 to refer to purchase information (S602) and display sales information on a screen as shown in FIG. 15 (S603). At the sales company 2, sales information is entered through a screen as shown in FIG. 15 (S604).

More specifically, first, the purchase information referring unit 8 receives a purchase information referring request from the sales company 2 or seller (S401). The purchase information referring unit 8 refers to the purchase information storing unit 7, and presents at least such information, out of the purchase information registered, as a type of goods “product A”, date “September 1”, quantity “10 units”, an wish-to-buy balance amount “−15 yen”, and an identifier “No. 0001 purchase information” which identify the purchase information to the sales company 2 (S402). At this time, if another purchase information is registered, the identifier specifying the purchase information will be “No. 0002 purchase information”, etc. Also, a marketable price “65 yen” (80 yen −15 yen) may be presented instead of the wish-to-buy balance amount “−15 yen” by referring to the “product A, sales company 2, 80 yen” in the goods broker's price storing unit 1.

The sales company 2, in a case where it desires a transaction to be made based on the contents of purchase information, makes a registration with the goods transaction system 0. In this case, first, the sales information receiving unit 2 receives sales information from a seller “sales company 2” who wishes to sell goods (S101). The sales information contains an identifier “sales company 2” specifying the seller, an identifier “No. 0001 purchase information” specifying purchase information, and quantity “10 units.” Next, the sales information receiving unit 2 judges whether the sales information contains an identifier specifying purchase information or not (S102). Here, since the sales information contains an identifier specifying purchase information, a transaction processing unit 6 achieves both buyer-seller contracts made “between a seller and a goods supplier” and “between a buyer and a goods supplier” (S106), and then, it deletes corresponding purchase information from the purchase information storing unit 7 (S107). Between “a seller and a goods supplier”, the cancellation of an order for a type of goods “product A”, date “September 1”, quantity “10 units” and a penalty “−15 yen” will be achieved, and between “a buyer and a goods supplier”, the buyer-seller contract of a new order for a type of goods “product A”, date “September 1”, quantity “10 units”, and a price “85 yen” will be achieved. The achievement of such transactions is notified to terminal units of the sales company 1 and the sales company 2 via a network. As a result, purchase information containing a type of goods “product A”, date “September 1”, quantity “10 units”, an wish-to-buy balance amount “−15 yen” and an identifier “No. 1 purchase information” specifying purchase information is deleted from the purchase information storing unit 7.

It should be noted that, in the above-described preferred embodiment (FIG. 15), an example where the quantity of purchase information is 10 units, and the quantity of sales information is also 10 units is shown. However, the quantity of sales information to be entered at the sales company 2 may be less than 10 units. In this case, a transaction will be achieved in part of the purchase information registered. Regarding the purchase information, the data of quantity is changed to a remaining quantity. This is the same as is the case shown in FIG. 12.

In the above-described preferred embodiment, an example where the sales company 1 desires to purchase goods at 90 yen is described. However, it can also be realized in other cases. For example, a case where, regarding goods which is purchased at a unit price of 100 yen from a manufacturer, a sales company 1 desires to purchase the goods even they would pay 110 yen for the goods will be described below.

First, a case where the wish to sell of the sales company 2 which is a seller is used as a trigger will be described. In this case, it shall be assumed that the sales company 2 desires to cancel the Order 1 even if they would pay a penalty of 10 yen. The sales company 2 registers a wish-to-sell balance amount of sales information, as “−10 yen” (wish-to-sell price; “70 yen”) with the sales information storing unit 3. Now, when the sales company 1 which is a seller accesses the goods transaction system 0 and retrieves the sales information, they will know that their desired goods are on sale at a unit price of 90 yen (The price is a purchasable price. See FIG. 12.) Therefore, the sales company 1 can purchase the goods at 90 yen (the wish-to-buy balance amount of the sales company 1 will therefore be “−10 yen”), and a transaction processing between the two companies through a manufacturer is executed by the computation of the transaction processing unit 6.

Next, a case where the wish to purchase of the sales company 1 which is a buyer is used as a trigger will be described. In this case, the sales company 1 registers the purchase information containing information of a wish-to-buy balance amount “+10 yen” (an wish-to-buy price: “110 yen”) with the purchase information storing unit 7. Now, when the sales company 2 which is a seller accesses the goods transaction system 0 and retrieves the purchase information, they can extract the information that there is a desire to purchase the purchasing right (Order 1) of the goods, the order for which the sales company 2 is going to cancel at a unit price of 90 yen. The information of the unit price of 90 yen is output to the terminal unit at the sales company 2 which is a seller and displayed there. Usually, it is necessary for the sales company 2 to pay a penalty fee to the manufacturer. However, in this case, they can sell the purchasing right of the goods at a higher price (unit price: 90 yen) than the price obtained at the time of placing an order to the manufacturer. The transaction processing is executed at the transaction processing unit 6, and the notification that the transaction has been achieved is transmitted to the terminal units at the sales company 1 and the sales company 2. It should be noted that, regarding the wish-to-sell balance amount “+10 yen” in this case, the goods transaction system 0 may be set so that the amount can be a profit (profit margin) of the sales company 2, a profit (charge) of the manufacturer, or profits (profit margin and charge) for both of the seller and the manufacturer.

As described above, with the preferred embodiment, the sharing of information such as sales information and purchase information can be realized among a plurality of goods brokers who purchase goods at different discount rates from a goods supplier.

With the present invention, even in a case where goods are sold from a goods supplier to a plurality of goods brokers at different discount rates, a transaction is executed by sharing information of a balance amount between a wish-to-sell price and a price at which the goods suppliers purchase from the goods supplier. Consequently, a goods broker can realize the transaction without worrying about the discount rate of a trading partner. Therefore, goods is unilaterally resold from a goods broker who has a higher discount rate to a goods broker who has a lower discount rate, and the direction of the sales will not be shifted. At the same time, profits are also secured for the goods supplier. Thus, the securement of profits for the goods supplier and a transaction of goods among goods brokers will be ensured at the same time.

With such arrangement, the goods broker can suppress a risk to retain goods and increase sales at the same time. The goods supplier can secure profits, increase gross sales, and reduce the total inventories.

The above detailed descriptions are provided to illustrate specific embodiments of the present invention and are not intended to be limiting. Numerous modifications and variations within the scope of the present invention are possible. Accordingly, the present invention is defined by the appended claims.

What is claimed is:

1. A method for performing a transaction amongst a plurality of participants including a first participant and a second participant, wherein the first and second participants purchase products of a given type from a product supplier at first and second purchase prices, respectively, the first and second purchase prices being different from each other, the method comprising:
receiving a first transaction information from the first participant wishing to perform a transaction in connection with one or more products of the given type with another participant, the first transaction information including at least price information on the one or more products without providing information on the first purchase price associated with the first participant; and
receiving a second transaction information from the second participant agreeing to transact with the first participant based on the first transaction information, the second transaction information not providing information on the second purchase price associated with the second participant.

2. The method of claim 1, further comprising:
displaying at least a portion of the first transaction information to the second participant, wherein the information displayed to the second participant provides a first transaction balance amount,
wherein the first transaction balance amount provides sufficient information to the second participant to determine a transaction price of the one or more products as realized by the second participant but insufficient for the second participant to determine the first purchase price associated with the first participant.

3. The method of claim 2, wherein the first transaction information is purchase information, the transaction price is a purchase price, and the first transaction balance amount is a wish-to-buy balance amount.

4. The method of claim 2, wherein the first transaction information is sales information, the transaction price is a sales price, and the first transaction balance amount is a wish-to-sell balance amount.

5. The method of claim 1, further comprising:
storing the first transaction information in an information receiving unit that is accessible to the plurality of participants;
receiving a first information request from the second participant, the first request providing one or more search criteria; and
upon determining that the first transaction information satisfies the search criteria, providing at least a portion of the first transaction information to the second participant, wherein the information provided to the second participant is sufficient for the second participant to determine a transaction price of the one or more products as realized by the second participant but insufficient for the second participant to determine the first purchase price associated with the first participant.

6. The method of claim 5, wherein the information provided to the second participant includes a first transaction balance amount, wherein the second transaction information including an identifier specifying the first transaction information.

7. The method of claim 6, wherein the first transaction information is purchase information and the first transaction balance amount is a wish-to-buy balance amount.

8. The method of claim 6, wherein the first transaction information includes a wish-to-transact price, further comprising:
retrieving the first purchase price associated with the first participant; and
calculating the first transaction balance amount using the wish-to-transact price and the first purchase price.

9. The method of claim 6, further comprising:
receiving a consent to enter into a transaction agreement with the first participant from the second participant; and
deleting the first transaction information from the information receiving unit.

10. The method of claim 9, wherein a first agreement between the first participant and the product supplier and a second agreement between the second participant and the product supplier are formed in response to the receipt of the consent from the second participant.

11. The method of claim 9, wherein the one or more products have not yet been manufactured by a manufacturer.

12. A method for trading a transactional right for a product in a network environment having a plurality of participants and a product supplier, the method comprising:
receiving sales information from a first participant for a purchase right to a product of a given type being supplied by the supplier, the first participant having agreed to pay a first purchase price to the supplier for the one or more products in connection with the purchase right;
providing information on the sales information to a second participant, the information on the sales information being insufficient for the second participant to determine the first purchase price but sufficient to enable the second participant to determine a total purchase price for the product; and
receiving an acceptance of the purchase right from the second participant based on the information provided on the sales information to the second participant.

13. The method of claim 12, further comprising:
forming a purchase agreement between the second participant and the supplier based on the acceptance by the second participant.

14. The method of claim 12, further comprising:
receiving a request for sales information from the second participant, the request including one or more search criteria.

15. The method of claim 12, wherein the information provided on the sales information provides a wish-to-sale balance amount.

16. The method of claim 12, further comprising:
receiving purchase information from a third participant for a purchase right to a product of the given type being supplied by the supplier; and
providing information on the purchase information to a fourth participant who wishes to purchase a purchase right to a product of the given type, the information on the purchase information providing a wish-to-buy balance amount.

17. The method of claim 12, wherein the total purchase price is sum of purchase prices paid to the supplier and the first participant.

18. A system for trading a purchase right to a product of a given type, comprising:
a server system coupled to a plurality of clients via the network, the server system being associated with the product supplier and the clients being associated with product brokers, the server system including an information storage area including:
code for receiving sales information from a first client for a purchase right to a product of a given type being supplied by the supplier, wherein a first product broker associated with the first client has agreed to pay a first purchase price to the supplier for the one or more products in connection with the purchase right;
code for providing information on the sales information to a second client, the information on the sales information being insufficient for a second product broker of the second client to determine the first purchase price but sufficient to enable the second user to determine a total purchase price for the product; and
code for receiving an acceptance of the purchase right from the second product broker based on the information provided on the sales information.

19. A computer readable medium storing information relating to a method for performing a transaction amongst a plurality of participants including a first participant and a second participant, wherein the first and second participants purchase products of a given type from a product supplier at first and second purchase prices, respectively, the first and second prices being different from each other, the medium comprising:
code for receiving a first transaction information from the first participant wishing to perform a transaction in connection with one or more products of the given type with another participant, the first transaction information including at least price information on the one or more products without providing information on the first purchase price associated with the first participant; and
code for receiving a second transaction information from the second participant agreeing to transact with the first participant based on the first transaction information, the second transaction information not providing information on the second purchase price associated with the second participant.

20. The computer medium of claim 19, further comprising:
code for storing the first transaction information in an information receiving unit that is accessible to the plurality of participants;
code for receiving a first information request from the second participant, the first request providing one or more search criteria; and
code for, upon determining that the first transaction information satisfies the search criteria, providing at least a portion of the first transaction information to the second participant,
wherein the information provided to the second participant is sufficient for the second participant to determine a transaction price of the one or more products realized by the second participant but insufficient for the second participant to determine the first purchase price associated with the first participant.
